(19) United States
(12) Patent Application Publication
(10) Pub. No.: US 2022/0250504 A1
(43) Pub. Date: Aug. 11, 2022

(54) RECOVERY STRATEGIES FOR BATTERY CAPACITY DATA LOSS AND CONTROL RELATED TO SAME

(71) Applicant: Ford Global Technologies, LLC, Dearborn, MI (US)

(72) Inventors: Rui Wang, Canton, MI (US); Andrea Cordoba Arenas, Ann Arbor, MI (US); Hesam Zomorodi Moghadam, Ypsilanti, MI (US); Xu Wang, Northville, MI (US)

(21) Appl. No.: 17/171,875

(22) Filed: Feb. 9, 2021

(51) Int. Cl. B60L 58/14; H02J 7/00

(52) U.S. Cl. CPC B60L 58/14; B60L 2240/427; H02J 7/00306; H02J 7/0063

(57) ABSTRACT

An automotive controller may, responsive to a loss of data indicative of a capacity of a traction battery and during charge of the traction battery, prevent a voltage of the traction battery from exceeding a threshold defined by a minimum value among a set of estimated battery capacities. The set includes an estimated battery capacity associated with a mileage of the vehicle and an estimated battery capacity associated with a number of drive days of the vehicle.

### TECHNICAL FIELD

The present disclosure relates to automotive power systems.

### BACKGROUND

Vehicles may include energy storage systems (e.g., traction batteries) that provide power for propulsion via electric machines. These traction batteries may be charged and discharged within limits that depend on capacity information associated with the traction batteries.

Battery capacity can change over time. As such, measured parameters including current and voltage are sometimes used to determine capacity information.

### SUMMARY

A vehicle includes an electric machine, a traction battery that provides power to and receives power from the electric machine, and a controller. The controller, during discharge of the traction battery and following data becoming unavailable, prevents a voltage of the traction battery from falling below a value defined by a mileage of the vehicle or a number of drive days of the vehicle. The data is indicative of a capacity of the traction battery learned during drive cycling of the traction battery.

A power system for an automotive vehicle includes a traction battery and a controller. The controller, responsive to a loss of data indicative of a capacity of the traction battery and during charge of the traction battery, prevents a voltage of the traction battery from exceeding a threshold defined by a minimum value among a set of estimated battery capacities. The set includes an estimated battery capacity associated with a mileage of the vehicle and an estimated battery capacity associated with a number of drive days of the vehicle.

A method includes automatically preventing, during discharge of a traction battery of a vehicle, a voltage of the traction battery from falling below a value defined by a mileage of the vehicle or a number of drive days of the vehicle.

### BRIEF DESCRIPTION OF THE DRAWINGS

FIG. 1 is a schematic diagram of a vehicle.

### DETAILED DESCRIPTION

Detailed embodiments are disclosed herein. They, however, are merely examples and may be embodied in various and alternative forms. The figures are not necessarily to scale. Some features may be exaggerated or minimized to show details of particular components. Specific structural and functional details disclosed herein are not to be interpreted as limiting, but merely as a representative basis for teaching one skilled in the art.

A variety of known techniques can be used to determine the capacity of a traction battery from sensed data. Due to noise associated with certain measurements however, obtaining an accurate value of battery capacity may involve iterative learning. A fixed proportional method, for example, employs a low pass filter with a time constant:

CAP(k+1)={X*100%*CAP(k)}+{(1−X)*100%*CAP_learn(k)} (1)

where CAP(k+1) is the next computed value for battery capacity, X is a predetermined constant, CAP(k) is the current computed value for battery capacity, and CAP_learn(k) is a value related to battery capacity.

Battery capacity information is often stored in memory of the vehicle. This memory, however, may become corrupted because the auxiliary battery that powers the memory becomes disconnected. This memory may also become corrupted during pack test events and normal writing operations. If the learned battery capacity information is unavailable, an initial battery capacity value may be assumed, and the iterative learning process described above may begin again. In some circumstances, a predetermined initial constant value (e.g., 70%) may be assumed. The capacity learning, however, may be slow if the actual capacity is much higher. It may take up to 60 learning cycles for example for equation 1 to converge on the actual value. For reference, a plug-in hybrid electric vehicle can take 1 to 2 months to complete 60 learning cycles. A battery electric vehicle can take 2 to 5 months to complete 60 learning cycles. During this period, drivers may experience reduced available power and driving range.

If the actual capacity is lower than the predetermined initial value, the capacity may be overestimated, which may lead to over charge or over discharge conditions: The calculated state of charge may be less than the actual state of charge at the top end, and the calculated state of charge may be greater than the actual state of charge at the bottom end.

As an alternative to resetting the capacity to a predetermined initial constant value, it may be reset to an estimate of worst-case expected capacity retention using vehicle mileage and days of usage information. Table 1 lists example capacity retention data by time and distance:

TABLE 1
Capacity Retention with respect to Mileage and Days of Usage

| Time | Distance | Capacity |
|---|---|---|
| (days) | (km) | Retention (%) |
| 0 | 0 | 100 |
| 225 | 15000 | 95.5 |
| 870 | 55000 | 89 |
| 1595 | 100000 | 84 |
| 2140 | 135000 | 80 |
| 3000 | 190000 | 75 |
| 3600 | 250000 | 71 |

The worst-case capacity retention for 2140 days and 100000 km would be 80%. The worst-case capacity retention for 3000 days and 250000 km would be 71%. This data may be determined ahead of time via simulation or testing and loaded with the vehicle during manufacture.

Current day and mileage information is typically available to certain battery control modules. Current day information can be computed from vehicle global clock data. Mileage can be obtained through a controller area network from the odometer.

Selecting the initial reset value for capacity as the worst-case capacity retention according to vehicle mileage and days of usage information can better approximate the actual value, which should reduce the iterative learning time needed to converge on the actual value and reduce instances of over charge or over discharge conditions.

Additional information, if available, can also be used. As the battery ages, the capacity decreases while internal resistance, R_0, increases. The internal resistance can be calculated using various known battery models and stored in memory for use. Also, electric vehicle mileage does not necessarily reflect the battery usage. Aggressive drivers can deplete the pack with much less mileage than passive drivers, such that the battery capacity can decrease much faster with respect to the mileage for aggressive drivers.

Other parameters can thus be used to reflect the actual usage of the battery pack. For example, the total accumulated amp-hours through the battery, ΣAh, and/or a root mean square current, I_rms, of the battery can be used. In addition, the depth of discharge may affect battery capacity. Customers who always discharge the battery to the minimum state of charge before charging may cause the battery to age faster than those who charge whenever possible. Average depth of discharge, DOD, may thus be a good indication of the charging behavior of a customer. Accumulated amp-hours, root mean square current, and depth of discharge can be calculated or measured using various known techniques and stored in memory for use.

Based on the above, a new equation can be formulated:

CAP_retention(k)=min(f(days), g(mileage),h(R_0),j(Σ_Ah),k(I_rms),m(DOD)) (2)

Given that each parameter is independent and may have an associated set of capacity retention values similar to that shown in Table 1, all need not be available to obtain an estimate of capacity retention. Those values that are available may be inspected, and the one having the lowest associated capacity retention may be selected.

Since Table 1 may represent the 90^{th} percentile worst-case capacity retention, the actual capacity may likely be higher than that from Table 1. Moreover, the capacity retention from equation 2 may be equal to or lower than that from Table 1. Therefore if a correlation between the internal resistance and the capacity is available from test data, it may be possible to increase the estimated capacity retention using the following equation:

CAP_1retention(k)=α(R₀)*CAP_1+(1−α(R₀))*CAP_norm (3)

where CAP_1 is from either equation 1 or equation 2, CAP_norm is the capacity of the pack when new, and the weighting factor, a(R₀), can be calculated from an equation or lookup table, similar to the one below:

TABLE 2
Weighting Factor with respect to Battery Internal Resistance

| R₀ | a(R₀) |
|---|---|
| 0 ≤ R₀ ≤ Threshold 1 | 0.5 |
| Threshold 1 ≤ R₀ ≤ Threshold 2 | 0.7 |
| Threshold 2 ≤ R₀ ≤ Threshold 3 | 0.9 |
| R₀ > Threshold 3 | 1.0 |

Battery capacity can be thought of, by analogy, as fuel tank size. In effect, as the battery capacity changes the fuel tank size changes. Hence, two otherwise same batteries with different capacities due to age, temperature, use, etc., will have different voltages when completely full.

The state of charge of a traction battery represents its level of charge relative to its estimated capacity. An empty traction battery can be at 0% state of charge and a supposedly full traction battery can be at 100% state of charge. Because the absolute level of charge the traction battery may hold varies with its estimated capacity however, the voltage of the traction battery at a particular state of charge (e.g., 20%, 80%, etc.) will vary based on its estimated capacity. Assuming for example that a battery at 100% estimated capacity has a voltage of 30 volts at 20% state of charge, the battery at 50% estimated capacity may have a voltage of 15 volts at 20% state of charge. Similarly, the battery at 100% estimated capacity may have a voltage of 60 volts at 80% state of charge, and at 50% estimated capacity a voltage of 30 volts at 80% state of charge, etc.

Battery capacity thus dictates the various voltage values that correspond to the various states of charge. If a battery has 100% estimated capacity, its voltage when full may be 10 volts. A voltage of 8 volts would then equate to a state of charge of 80% while a voltage of 2 volts would equate to a state of charge of 20%. If the battery has 50% estimated capacity, its voltage when full may be 6 volts. A voltage of 4.8 volts would then equate to a state of charge of 80% while a voltage of 1.2 volts would equate to a state of charge of 20%, etc. The voltage values associated with 100% estimated capacity for a given battery may be determined via testing or simulation, or be obtained from the battery manufacturer.

To extend life, certain traction batteries may be controlled such that during charge their state of charge does not exceed an upper limit (e.g., 85%), and during discharge their state of charge does not fall below a lower limit (e.g., 30%). That is, once the battery state of charge achieves the upper limit, charging is discontinued; once the battery state of charge reaches the lower limit, discharging is discontinued. And for the reasons explained above, the voltage of the traction battery at the upper limit may differ over time depending on the estimated capacity of the traction battery, and the voltage of the traction battery at the lower limit may differ over time depending on the estimated capacity.

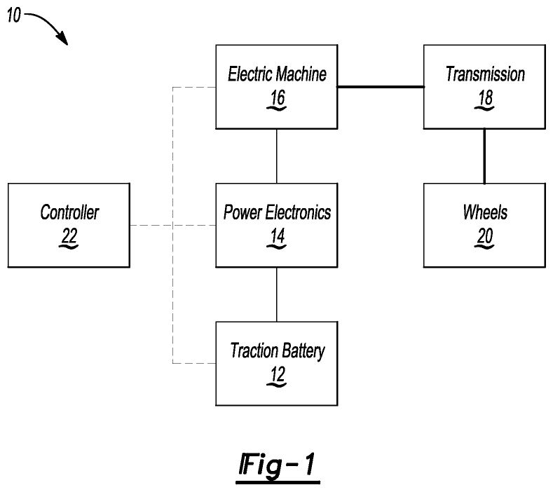

With reference to FIG. 1, a vehicle 10 includes a traction battery 12, power electronics 14 (e.g., an inverter, etc.), an electric machine 16, a transmission 18, wheels 20, and one or more controllers 22. The traction battery 12 is arranged to provide power to or receive power from the electric machine 16 via the power electronics 14. During propulsion of the vehicle 10, the electric machine 16 may convert electrical energy from the traction battery 12 to mechanical energy to drive the transmission 18, which in in turn, propels the wheels 20. During regenerative braking of the vehicle 10, the electric machine may exert a braking torque on a drive shaft associated with the transmission 18 to convert mechanical energy associated with movement of the wheels 20 to electrical energy for storage in the traction battery 12.

The one or more controllers 22 are in communication with and/or exert control over the traction battery 12, power electronics 14, and electric machine 16. Such communication and/or control may be facilitated by a controller area network or the like. Further, the one or more controllers 22 may compute and store learned capacity data for the traction battery 12 as described above. Responsive to loss of such data, which may be indicated by presence of a fault flag or an inaccessible memory location, the one or more controllers 22 may select an initial estimated capacity value using the strategies contemplated herein. Such selection may thus impact voltage values associated with upper and lower state of charge thresholds for the traction battery 12. The one or more controllers 22 may then take measures to prevent the state of charge of the traction battery 12 from exceeding (during charge) or falling below (during discharge) upper and lower state of charge thresholds. By doing so, it thus prevents the voltage of the traction battery 12 from exceeding a certain value during charge or from falling below a certain value during discharge by because for a given estimated capacity, the upper and lower state of charge thresholds correspond to certain voltage values.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as Read Only Memory (ROM) devices and information alterably stored on writeable storage media such as floppy disks, magnetic tapes, Compact Discs (CDs), Random Access Memory (RAM) devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While example embodiments are described above, it is not intended that these embodiments describe all possible forms encompassed by the claims. The words used in the specification are words of description rather than limitation, and it is understood that various changes can be made without departing from the spirit and scope of the disclosure.

The features of various embodiments can be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
an electric machine;
a traction battery configured to provide power to and receive power from the electric machine; and
a controller programmed to, during discharge of the traction battery and following data becoming unavailable, prevent a voltage of the traction battery from falling below a value defined by a mileage of the vehicle or a number of drive days of the vehicle, wherein the data is indicative of a capacity of the traction battery learned during drive cycling of the traction battery.

2. The vehicle of claim 1, wherein the value is a function of an estimated capacity of the traction battery and wherein the controller is further programmed to select the estimated capacity based on the mileage or drive days.

3. The vehicle of claim 2, wherein selecting the estimated capacity based on the mileage or drive days includes selecting the estimated capacity as a lesser of a capacity value associated with the mileage and a capacity value associated with the drive days.

4. The vehicle of claim 2, wherein the estimated capacity is further a function of an estimated internal resistance of the traction battery.

5. The vehicle of claim 1, wherein the controller is further programmed to, during charge of the traction battery and following the data becoming unavailable, prevent the voltage from exceeding another value defined by the mileage or number of drive days.

6. The vehicle of claim 1, wherein preventing the voltage from falling below the value includes discontinuing the discharge.

7. A power system for an automotive vehicle, comprising:
a traction battery; and
a controller programmed to, responsive to loss of data indicative of a capacity of the traction battery and during charge of the traction battery, prevent a voltage of the traction battery from exceeding a threshold defined by a minimum value among a set of estimated battery capacities, wherein the set includes an estimated battery capacity associated with a mileage of the vehicle and an estimated battery capacity associated with a number of drive days of the vehicle.

8. The power system of claim 7, wherein the set includes an estimated battery capacity associated with an internal resistance of the traction battery.

9. The power system of claim 7, wherein the set includes an estimated battery capacity associated with an accumulated amp-hours of the traction battery.

10. The power system of claim 7, wherein the set includes an estimated battery capacity associated with a root mean square current of the traction battery.

11. The power system of claim 7, wherein the set includes an estimated battery capacity associated with an average depth of discharge of the traction battery.

12. The power system of claim 7, wherein the controller is further programmed to, responsive to the loss of data and during discharge of the traction battery, prevent the voltage battery from falling below another threshold defined by the minimum value.

13. The power system of claim 7, wherein preventing the voltage from exceeding the threshold includes discontinuing the charge.

14. A method comprising:
automatically preventing, during discharge of a traction battery of a vehicle, a voltage of the traction battery from falling below a value defined by a mileage of the vehicle or a number of drive days of the vehicle.

15. The method of claim 14 further comprising automatically preventing, during charge of the traction battery, the voltage from exceeding another value defined by the mileage or number of drive days.

16. The method of claim 14, wherein the value is a function of an estimated capacity of the traction battery, further comprising selecting the estimated capacity based on the mileage or drive days.

17. The method of claim 16, wherein the selecting includes selecting the estimated capacity as a lesser of a capacity value associated with the mileage and a capacity value associated with the drive days.

18. The method of claim 16, wherein the estimated capacity is further a function of an estimated internal resistance of the traction battery.
